(19) United States
(12) Patent Application Publication
(10) Pub. No.: US 2015/0019230 A1
(43) Pub. Date: Jan. 15, 2015

(54) Method and Apparatus for Sending Information Codes with Audio Signals and Obtaining Information Codes

(71) Applicant: WOCHACHA INFORMATION TECHNOLOGY (SHANGHAI) CO., LTD., Shanghai (CN)

(72) Inventors: Lixin Zhao, Shanghai (CN); Hongzhou Chen, Shanghai (CN); Yingjun Ge, Shanghai (CN)

(21) Appl. No.: 14/365,285

(22) PCT Filed: Dec. 12, 2012
(86) PCT No.: PCT/CN2012/086460

§ 371 Date: Oct. 1, 2014

(30) Foreign Application Priority Data
Dec. 13, 2011 (CN) 201110415718.3

(51) Int. Cl. G10L 19/018

(52) U.S. Cl. CPC G10L 19/018
USPC 704/500

(57) ABSTRACT

The invention relates to a method and apparatus for sending an information code via an audio signal and retrieving an information code. The method of sending an information code via an audio signal includes the steps of: modulating the information code and a sync header into the audio signal in a second band; and transmitting the modulated audio signal in the second band directly, or superimposing and then transmitting the modulated audio signal in the second band with an audio signal in a first band, wherein the first band is different from the second band.

### FIELD OF THE INVENTION

The present disclosure relates to the field of signal encoding and decoding, and particularly to a method and apparatus for sending an information code via an audio signal and retrieving an information code.

### BACKGROUND OF THE INVENTION

At present a large number of merchants advertise their products and publish information over television, radio, magazines and other media, but generally can neither expand the characteristics of the products nor enable audiences to memorize the contents of the products and means to purchase and search for the products very soon due to a limited size and period of time, thus typically failing to achieve their advertisement and dissemination effects, especially in the case that the audiences accept such information in a mobile place, e.g., in a vehicle, on the way or in another occasional place.

As investigated but not in its entirety, merchants all over the world have spent hundreds of millions dollars annually on advertisement and dissemination over medias, but not more than 50% has been really translated into attention of consumers while not more than 20% has been translated into their purchases, and also there are a large number of merchants disseminating their products over magazines or color sheets on which a one-dimension or two-dimension bar code is printed as an entry to information search or to purchasing. However this one-dimension or two-dimension bar code may not be suitable for numerous application scenarios, for example, it is rather difficult to adopt a bar code as an information carrier in television, movie or radio.

### SUMMARY OF THE INVENTION

In view of this, the invention is intended to propose a method and apparatus for adding an information code to an audio and a method and apparatus for identifying the information code for the purpose of loading information easily retrievable by a user in radio, television and other media.

According to a first aspect of the invention, there is proposed a method of sending an information code via an audio signal, the method including the steps of: A. modulating the information code and a sync header into the audio signal in a second band; and B. transmitting the modulated audio signal in the second band directly, or superimposing and then transmitting the modulated audio signal in the second band with an audio signal in a first band, wherein the first band is different from the second band.

Advantageously the sync header is modulated cyclically into the audio signal in the second band at a cycling interval of not more than 20 minutes. The advantage thereof is that the receiving device of the audio signal has several opportunities to receive the repeated sync header to thereby judge the starting position of the information code data more easily and accurately.

Advantageously the sync header is a kind of fixed data and the fixed data is different from data in the information code. The advantage thereof is that the receiving device of the audio signal can identify the sync header accurately without mistakenly taking the data in the information code as the sync header.

Advantageously the second band is an ultrasonic band or an infrasonic band. The advantage thereof is that the audio signal in the second band can be played together with another audio or video signal without any influence on normally listening or watching of the other audio or video signal because the ultrasonic band or the infrasonic band is inaudible to average human ears.

According to a second aspect of the invention, there is proposed a method of retrieving an information code, the method including the steps of: a. receiving a transmission audio signal, wherein the transmission audio signal includes an audio signal in a second band and the audio signal in the second band is modulated with the information code and a sync header, or the transmission audio signal is a superimposition of the audio signal in the second band modulated with the information code and the sync header and an audio signal in a first band, wherein the first band is different from the second band; b. retrieving the audio signal in the second band from the received transmission audio signal; and c. demodulating the audio signal in the second band to retrieve the information code.

According to a third aspect of the invention, there is proposed an apparatus for sending an information code via an audio signal, the apparatus including: a modulating device configured to modulate the information code and a sync header into the audio signal in a second band to generate a transmission audio signal; and a transmitting device configured to transmit the transmission audio signal.

Advantageously the apparatus further includes a superimposition device configured to superimpose the modulated audio signal in the second band with an audio signal in a first band to generate a transmission audio signal, wherein the first band is different from the second band.

According to a fourth aspect of the invention, there is proposed an apparatus for retrieving an information code from a transmission audio signal, the apparatus including: a receiving device configured to receive the transmission audio signal, wherein the transmission audio signal includes an audio signal in a second band and the audio signal in the second band is modulated with the information code and a sync header, or the transmission audio signal is a superimposition of the audio signal in the second band modulated with the information code and the sync header and an audio signal in a first band, wherein the first band is different from the second band; a retrieval device configured to retrieve the audio signal in the second band from the received transmission audio signal; and a demodulating device configured to demodulate the audio signal in the second band to retrieve the information code.

According to a fifth aspect of the invention, there is proposed a mobile communication device including the apparatus for retrieving an information code from a transmission audio signal according to the fourth aspect. The advantage thereof is that the information code and thus information can be retrieved at any time anywhere by a handset which is a communication facility the mostly applied today.

### BRIEF DESCRIPTION OF DRAWINGS

The foregoing and other objects, features and advantages of the invention will become more apparent from the following detailed description of non-limiting embodiments of the invention with reference to the drawings in which:

FIG. 1 illustrates a flow chart of a method of sending an information code via an audio signal according to an embodiment of the invention;

FIG. 1a illustrates a schematic diagram of modulation of a sync header and binary code data in a carrier signal according to an embodiment of the invention;

FIG. 2 illustrates a flow chart of a method of sending an information code via an audio signal according to another embodiment of the invention;

FIG. 3 illustrates a flow chart of a method of retrieving an information code according to another embodiment of the invention;

FIG. 4 illustrates a block diagram of an apparatus for sending an information code via an audio signal according to an embodiment of the invention;

FIG. 4a illustrates a schematic diagram of modulation, by a modulating device in the apparatus for sending an information code via an audio signal, of a sync header and the information code in a carrier signal according to an embodiment of the invention;

FIG. 5 illustrates a block diagram of an apparatus for sending an information code via an audio signal according to another embodiment of the invention; and

FIG. 6 illustrates a block diagram of an apparatus for retrieving an information code according to another embodiment of the invention.

### DETAILED DESCRIPTION OF EMBODIMENTS

Although a detailed description of various embodiments of the invention will be set forth hereinafter, it shall be appreciated that the claimed scope of the invention will be defined literally as in the appended claims of this patent application. The detailed description shall be construed to be merely exemplary but not to describe every possible embodiment of the invention because it may be impractical, even if possible, to describe every possible embodiment. Various alternate embodiments can be possible with the use of technologies currently known or to be developed later than the filing data of this patent application without departing from the scope of the claims of the invention.

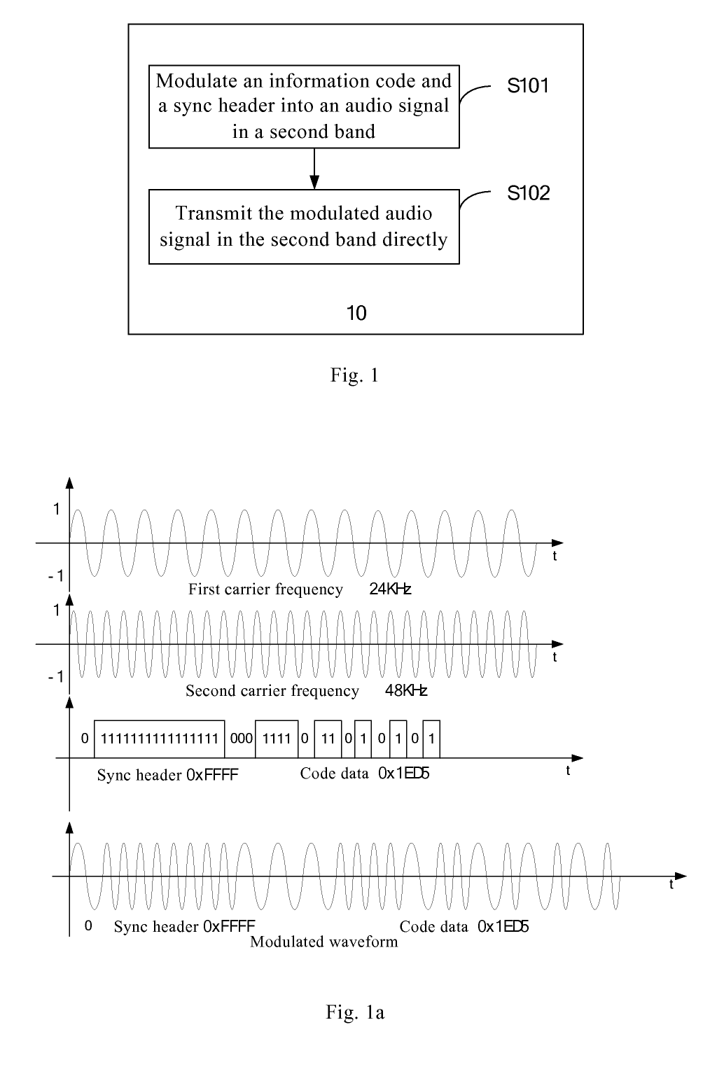

FIG. 1 illustrates a flow chart of a method 10 of sending an information code via an audio signal according to an embodiment of the invention. For example, a video advertisement relating to a specific product is produced in which a video is, e.g., a silent video, and here the so-called silent video refers to a video including a video segment and also possibly an ultrasonic or infrasonic audio segment, where the video segment includes a picture of the product, a literal introduction of the product or other information about the product, and the information related to the product, e.g., the name, the price, the web address, the index, etc., thereof, can also be embodied in the method of sending an information code via an ultrasonic or infrasonic audio signal according to the invention.

Specifically taking the product name as an example, first an information code of the product name, e.g., the binary code, is retrieved through specific encoding or mapping, or the information code itself exists in the form of the binary code, for example, the binary code of the name is a set of 16-bit binary digits 0x1ED5 (binary digits represented in hex) or can be 24 bits, 32 bits, 64 bits or more dependent upon the length of the name thereof. Thereafter as illustrated in FIG. 1 showing steps of the method 10 of sending an information code via an audio signal according to an embodiment of the invention, in the step S101, first the set of 16-bit binary digits 0x1ED5 and a sync header are modulated into an audio signal in the second band, where the sync header is a kind of fixed data for judging the position of the information code, for example, the sync header is 0xFFFF (binary digits represented in hex) or of course can be 0x0000, 0xFFFFFFFF, etc., and neither the contents nor the number of bits thereof will be limited in the invention. Moreover the sync header 0xFFFF is different from the data in the information code so that the sync header can be identified accurately upon reception without mistakenly taking the data in the information code as the sync header, that is, for example, the binary code of the information code is a code of more than 16 bits, e.g., 64 bits or 128 bits, and then the same part of the data as the sync header 0xFFFF will not be present in the 64-bit or 128-bit binary code. Of course the foregoing description is merely illustrative but shall not be construed to limit the number of bits and the form of the information code and the sync header. Moreover the sync header 0xFFFF is cyclic in the audio signal, for example, the sync header 0xFFFF is modulated cyclically into the audio signal, preferably at an interval of not more than 20 minutes, e.g., 15 seconds or 60 seconds. Thus the repeated sync header 0xFFFF can be received on a number of occasions during reception so that the starting position of the information code, i.e., the binary code data 0x1ED5, can be judged more easily and accurately. Furthermore the second band of the audio signal is an ultrasonic band of, e.g., 24 KHz and 48 KHz or an infrasonic band of, e.g., 15 Hz and 7.5 Hz, which is inaudible to human ears; and additionally the modulation scheme can be frequency modulation or amplitude modulation or phase modulation or another modulation scheme. FIG. 1a illustrates a schematic diagram of modulation of the sync header 0xFFFF and the binary code data 0x1ED5 in audio signals at 24 KHz and 48 KHz respectively.

As illustrated in FIG. 1a, two carrier signals are carrier audio signals respectively at the first frequency of 24 KHz and the second frequency of 48 KHz, and moreover the sync header 0xFFFF and the binary code data 0x1ED5 are represented digitally as illustrated, where a high level represents the logic “1”, and a zero level represents the logic “0”. Lastly there is illustrated a schematic diagram of a modulated waveform, where a carrier signal at the frequency of 48 KHz in a cycle represents the logic “1”, and a carrier signal at the frequency of 24 KHz in a cycle represents the logic “0”. In this embodiment, the binary code data 0x1ED5 follows immediately the sync header, but the invention will not be limited thereto, and instead there may be a specific interval between the sync header and the binary data.

Thereafter in the step S102, the modulated audio signals in the second band, e.g., at 24 KHz and 48 KHz, are transmitted together with the video signal. For example the transmitted audio signals or video signal can be played directly by a media player provided with an ultrasonic speaker, or alternatively can be sent to a specific memory and stored as a specific audio-video file so as to be invoked for playing at any time or can be stored directly in a specific storage medium, e.g., a magnetic tape. Specifically, for example, it can be produced by an advertisement company as a specific advertisement product and stored in a magnetic tape so as to be transmitted to a television station for playing.

Thus on one hand, the video signal includes the picture of the product, i.e., perceptive awareness of the product, e.g., the structure, the color, the shape, etc., thereof; and on the other hand, the audio signal in the second band modulated with the information about the name, the price, the website, index or a combination thereof includes the further detailed description of the product.

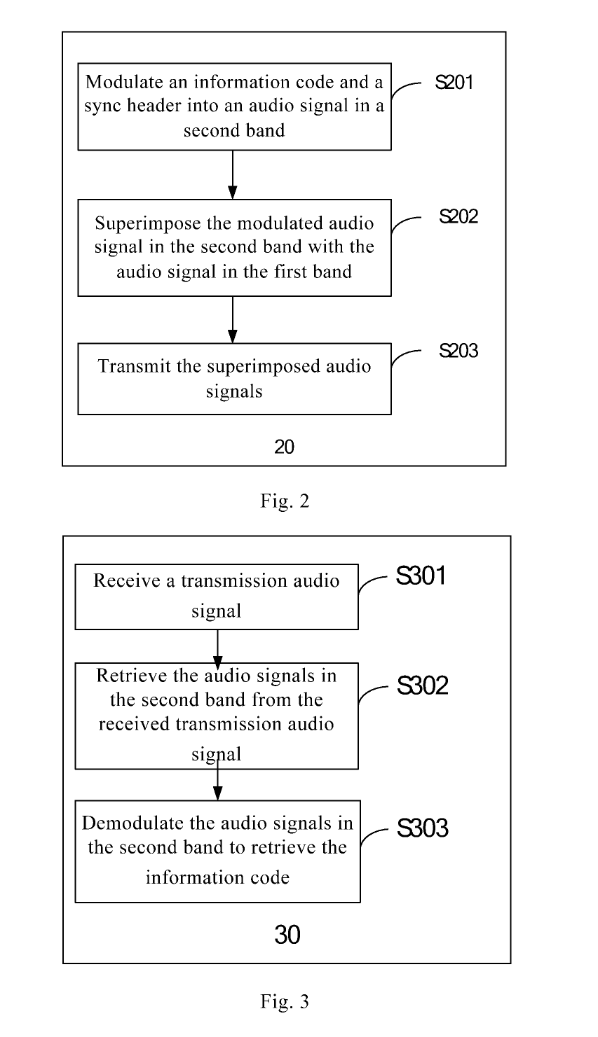

FIG. 2 illustrates a flow chart of a method 20 of sending an information code via an audio signal according to another embodiment of the invention. For example, a video advertisement relating to a specific product is produced again in which a video is a phonic video unlike the embodiment described above in FIG. 1, that is, the video advertisement includes both a video segment and an audio segment in the first band audible to human ears. Of course the video segment of the video advertisement is used to play the picture of the product, and the audio segment in the first band is used to play dissemination information, e.g., advertisement words, which can enter rapidly and reside persistently in the human brain, and other information about the product, e.g., the name, the price, the web address, the index or a combination thereof can also be embodied in the method of sending an information code via an audio signal according to the invention.

Specifically taking the product price as an example, first an information code of price information of the product, e.g., the binary code, is retrieved through specific encoding or mapping, or the information code itself exists in the form of the binary code, for example, the binary code of the price information is a set of 24-bit binary digits 0x1ED5DA (binary digits represented in hex) or can be 16 bits, 32 bits, 64 bits or more dependent upon the length of the price information thereof. Thereafter as illustrated in FIG. 2 showing steps of the method 20 of sending an information code via an audio signal according to an embodiment of the invention, in the step S201, first the set of binary digits 0x1ED5DA (binary digits represented in hex) and a sync header are modulated into an audio signal in the second band, where the sync header is a kind of fixed data for judging the position of the information code, for example, the sync header is 0xFFFFFF (binary digits represented in hex) or of course can be 0x0000, 0xFFFFFFFF, etc., and neither the contents nor the number of bits thereof will be limited in the invention. Moreover the sync header 0xFFFFFF is different from the data in the information code so that the sync header can be identified accurately upon reception without mistakenly taking the data in the information code as the sync header, that is, for example, the binary code of the information code is a code of more than 24 bits, e.g., 64 bits or 128 bits, and then the same part of the data as the sync header 0xFFFFFF will not be present in the 64-bit or 128-bit binary code. Of course the foregoing description is merely illustrative but shall not be construed to limit the number of bits and the form of the information code and the sync header. Moreover the sync header 0xFFFFFF is cyclic in the audio signal and preferably cycled at an interval of not more than 20 minutes. Thus the repeated sync header 0xFFFFFF can be received on a number of occasions during reception so that the starting position of the information code data 0x1ED5DA can be judged more easily and accurately. Furthermore the second band of the audio signal is an ultrasonic band of, e.g., 24 KHz or an infrasonic band of, e.g., 15 Hz, which is inaudible to average human ears; and additionally the modulation scheme can be frequency modulation or amplitude modulation or phase modulation or another modulation scheme.

Thereafter in the step S202, the modulated audio signal in the second band of 24 KHz or 15 Hz is superimposed with the audio signal in the first band. Finally in the step S203, the superimposed audio signals in the first band and the second band are transmitted together with the video signal for playing. Thus the video signal includes the picture of the product, i.e., perceptive awareness of the product, e.g., the structure, the color, the shape, etc., thereof; and the impression of the product can be enhanced by listening to the audio signal in the first band; and lastly the audio signal in the second band modulated with the information about the name, the price, the website, index or a combination thereof includes the further detailed description of the product.

FIG. 3 illustrates a flow chart of a method 30 of retrieving an information code according to another embodiment of the invention.

For example, a specific video advertisement is being played, where the video advertisement can be a silent video or a phonic video, that is, the video advertisement may or may not include an audio segment in the first band audible to human ears. Of course the video segment of the video advertisement is used to play the picture of the product, and the audio segment in the first band is used to play dissemination information, e.g., advertisement words, which can enter rapidly and reside persistently in the human brain, and other information about the product, e.g., the name, the price, the web address, the index or a combination thereof can be modulated into an audio signal in the second band in the form of the information code, where the second band is an ultrasonic band or an infrasonic band so as to avoid the influence on listening to the audio or watching the video in the first band; and additionally the modulation scheme can be frequency modulation or amplitude modulation or phase modulation. Typically the video segment and the audio segment of the video advertisement (only in the second band or in both the first band and the second band) are transmitted together for playing.

Specifically the audio signal in the second band in the video advertisement being played is modulated, for example, with the price information code of the product, for example, the binary code of the price information is a set of 24-bit binary digits 0x1ED5DA (binary digits represented in hex) or can be 16 bits, 32 bits, 64 bits or more dependent upon the length thereof. In order to retrieve the information code and thus the information, as illustrated in FIG. 3 showing steps of the method 30 of retrieving an information code according to an embodiment of the invention, first in the step S301, a transmission audio signal is received, where the transmission audio signal can only include an audio signal in the second band, e.g., of 24 KHz and 48 KHz (for example, modulated digitally at the first carrier frequency of 24 KHz and the second carrier frequency of 48 KHz), and the audio signal is modulated with a price information code 0x1ED5DA and a sync header 0xFFFFFF; or the transmission audio signal is superimposition of both the audio signal modulated with the price information code 0x1ED5DA and the sync header 0xFFFFFF and an audio signal in the first band. Specifically, for example, the audio signals at 24 KHz and 48 KHz modulated with the price information code 0x1ED5DA and the sync header 0xFFFFFF can be received by an audio sensor integrated in a mobile communication device, e.g., a handset, and converted into a digital audio signal and stored in a buffer. Thereafter in the step S302, the audio signals at 24 KHz and 48 KHz are retrieved from the received transmission audio signal, where if the received transmission audio signal includes only the audio signals at 24 KHz and 48 KHz, then they can be retrieved directly; and if the received transmission audio signal includes the audio signals at 24 KHz and 48 KHz and also the audio signal in the first band, then the audio signals at 24 KHz and 48 KHz can first be separated, e.g., filtered (high-pass or low-pass), from the audio signal in the first band, and then retrieved. Specifically the audio signals at 24 KHz and 48 KHz, modulated with the price information code 0x1ED5DA and the sync header 0xFFFFFF, stored in the buffer can be extracted by a corresponding high-pass filter while filtering out the audio signal in the first band.

Finally in the step S303, the audio signals at 24 KHz and 48 KHz are demodulated to retrieve the information code 0x1ED5DA, where the audio signals in the second band are modulated with the price information code 0x1ED5DA and the sync header 0xFFFFFF, and the sync header is a kind of fixed data for judging the position of the information code. Moreover, of course, the sync header can alternatively be 0x0000, 0xFFFFFFFF, etc., and neither the contents nor the number of bits thereof will be limited in the invention. Moreover the sync header 0xFFFFFF is different from the data in the information code 0x1ED5DA so that the sync header can be identified accurately upon reception without mistakenly taking the data in the information code as the sync header, that is, the binary code of the information code is a code of more than 24 bits, e.g., 64 bits or 128 bits, and then the same part of the data as the sync header 0xFFFFFF will not be present in the 64-bit or 128-bit binary code. Of course the foregoing description is merely illustrative but shall not be construed to limit the number of bits and the form of the information code and the sync header. Moreover the sync header 0xFFFFFF is cyclic in the audio signal and preferably cycled at an interval of not more than 20 minutes. Thus the repeated sync header 0xFFFFFF can be received on a number of occasions during reception so that the starting position of the information code data 0x1ED5DA can be judged more easily and accurately. Furthermore the corresponding demodulation scheme can be adopted with respect to the modulation scheme of frequency modulation or amplitude modulation or phase modulation. Specifically in this embodiment, for example, the retrieved audio signals at 24 KHz and 48 KHz can demodulated in a handset to retrieve the digital information codes modulated therein including the sync header 0xFFFFFF and the price information code 0x1ED5DA. Specifically in this embodiment, since the digital information code is modulated digitally, it can be demodulated in an incoherent demodulation scheme (including envelope detection) and a coherent demodulation scheme (sync detection), for example, the incoherent demodulation scheme includes frequency discrimination, split filter envelope detection, zero-crossing detection, etc. After demodulation, first the sync header 0xFFFFFF is located, and thereafter the position of the information code 0x1ED5DA can be judged from the sync header to thereby obtain the information code 0x1ED5DA. Then the price information of the product can be retrieved by the information code 0x1ED5DA through specific encoding or mapping or directly.

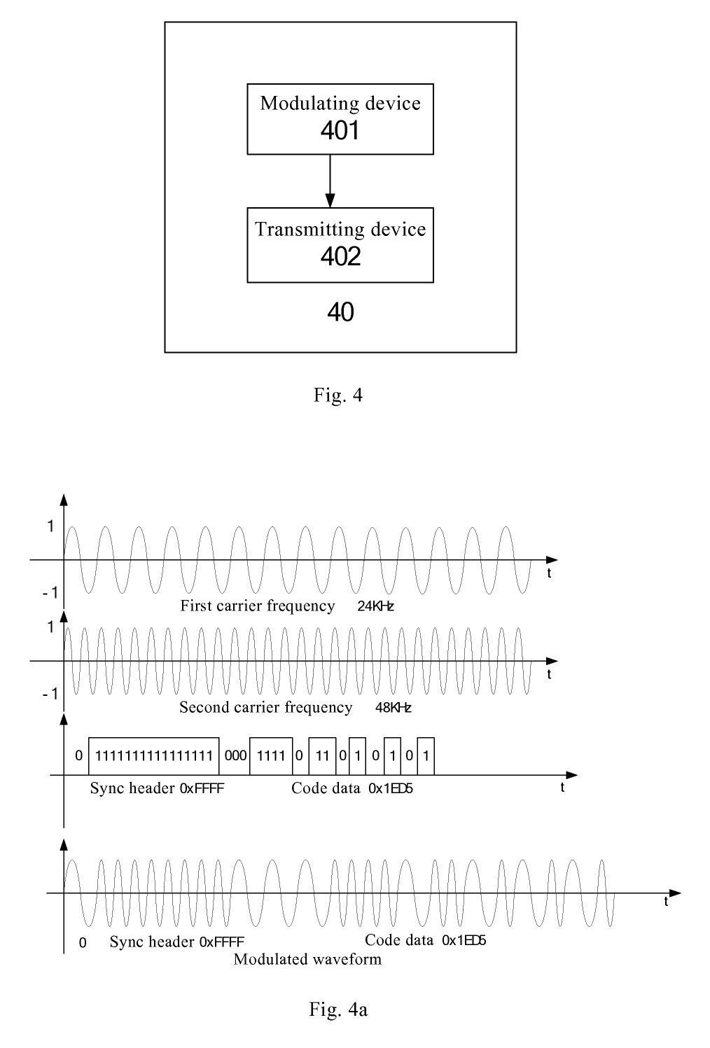

FIG. 4 illustrates a block diagram of an apparatus 40 for sending an information code via an audio signal according to an embodiment of the invention. For example, a video advertisement relating to a specific product is produced in which a video is, e.g., a silent video, and here the so-called silent video refers to a video including a video segment and also possibly an ultrasonic or infrasonic audio segment, where the video segment includes a picture of the product, a literal introduction of the product or other information about the product, and the information related to the product, e.g., the name, the price, the web address, the index, etc., thereof, can also be embodied in the method of sending an information code via an ultrasonic or infrasonic audio signal according to the invention.

Specifically taking the product name as an example, first an information code of the product name, e.g., the binary code, is retrieved through specific encoding or mapping, or the information code itself exists in the form of the binary code, for example, the binary code of the name is a set of 16-bit binary digits 0x1ED5 (binary digits represented in hex) or can be 24 bits, 32 bits, 64 bits or more dependent upon the length of the name thereof. Thereafter as illustrated in FIG. 4, first a modulating device 401 in the apparatus 40 for sending an information code via an audio signal according to an embodiment of the invention modulates the set of 16-bit binary digits 0x1ED5 and a sync header into an audio signal in the second band, where the sync header is a kind of fixed data for judging the position of the information code, for example, the sync header is 0xFFFF (binary digits represented in hex) or of course can be 0x0000, 0xFFFFFFFF, etc., and neither the contents nor the number of bits thereof will be limited in the invention. Moreover the sync header 0xFFFF is different from the data in the information code so that the sync header can be identified accurately upon reception without mistakenly taking the data in the information code as the sync header, that is, for example, the binary code of the information code is a code of more than 16 bits, e.g., 64 bits or 128 bits, and then the same part of the data as the sync header 0xFFFF will not be present in the 64-bit or 128-bit binary code. Of course the foregoing description is merely illustrative but shall not be construed to limit the number of bits and the form of the information code and the sync header. Moreover the sync header 0xFFFF is cyclic in the audio signal and preferably cycled at an interval of not more than 20 minutes, e.g., 15 seconds or 60 seconds. Thus the repeated sync header 0xFFFF can be received on a number of occasions during reception so that the starting position of the information code, i.e., the binary code data 0x1ED5, can be judged more easily and accurately. Furthermore the second band of the audio signal is an ultrasonic band of, e.g., 24 KHz and 48 KHz or an infrasonic band of, e.g., 15 Hz and 7.5 Hz, which is inaudible to human ears; and additionally the modulation scheme can be frequency modulation or amplitude modulation or phase modulation or another modulation scheme. FIG. 4a illustrates a schematic diagram of modulation, by the modulating device 401, of the sync header 0xFFFF and the binary code data 0x1ED5 in carrier signals at 24 KHz and 48 KHz.

As illustrated in FIG. 4a, two carrier signals adopted by the modulating device 401 are carrier audio signals respectively at the first frequency of 24 KHz and the second frequency of 48 KHz, and moreover the sync header 0xFFFF and the binary code data 0x1ED5 are represented digitally as illustrated, where a high level represents the logic “1”, and a zero level represents the logic “0”. Lastly there is illustrated a schematic diagram of a modulated waveform, where a carrier signal at the frequency of 48 KHz in a cycle represents the logic “1”, and a carrier signal at the frequency of 24 KHz in a cycle represents the logic “0”. In this embodiment, the binary code data 0x1ED5 follows immediately the sync header, but the invention will not be limited thereto, and instead there may be a specific interval between the sync header and the binary data.

Thereafter the transmitting device 402 in the apparatus 40 for sending an information code via an audio signal according to an embodiment of the invention transmits the modulated audio signals in the second band, e.g., at 24 KHz and 48 KHz, together with the video signal. For example the transmitted audio signals or video signal can be played directly by a media player provided with an ultrasonic speaker, or alternatively can be sent to a specific memory and stored as a specific audio-video file so as to be invoked for playing at any time or can be stored directly in a specific storage medium, e.g., a magnetic tape. Specifically, for example, it can be produced by an advertisement company as a specific advertisement product and stored in a magnetic tape so as to be transmitted to a television station for playing.

Thus on one hand, the video signal includes the picture of the product, i.e., perceptive awareness of the product, e.g., the structure, the color, the shape, etc., thereof; and on the other hand, the audio signal in the second band modulated with the information about the name, the price, the website, index or a combination thereof includes the further detailed description of the product.

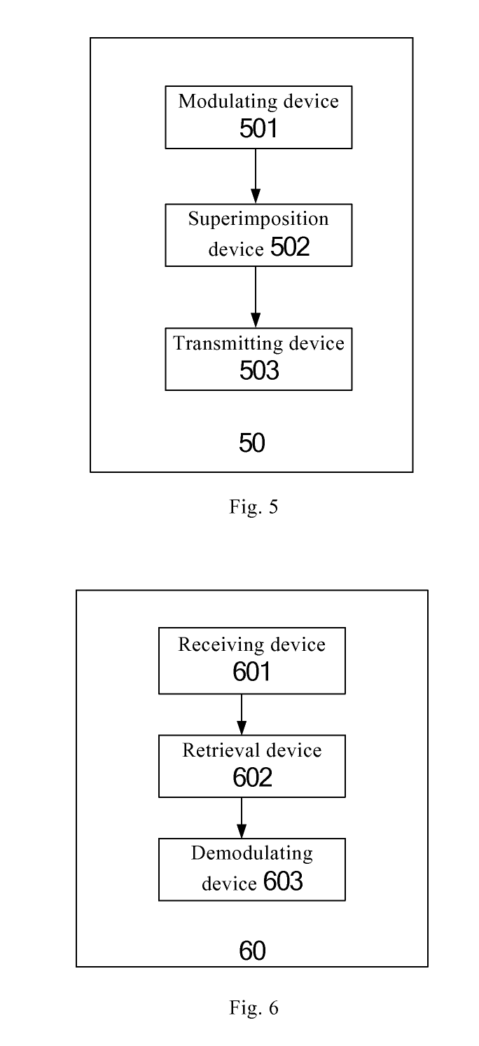

FIG. 5 illustrates a block diagram of an apparatus 50 for sending an information code via an audio signal according to another embodiment of the invention. For example, a video advertisement relating to a specific product is produced again in which a video is a phonic video unlike the embodiment described above in FIG. 4, that is, the video advertisement includes both a video segment and an audio segment in the first band audible to human ears. Of course the video segment of the video advertisement is used to play the picture of the product, and the audio segment in the first band is used to play dissemination information, e.g., advertisement words, which can enter rapidly and reside persistently in the human brain, and other information about the product, e.g., the name, the price, the web address, the index or a combination thereof can also be embodied in the method of sending an information code via an audio signal according to the invention.

Specifically taking the product price as an example, first an information code of price information of the product, e.g., the binary code, is retrieved through specific encoding or mapping, or the information code itself exists in the form of the binary code, for example, the binary code of the price information is a set of 24-bit binary digits 0x1ED5DA (binary digits represented in hex) or can be 16 bits, 32 bits, 64 bits or more dependent upon the length thereof. Thereafter as illustrated in FIG. 5, the demodulating device 501 in the apparatus 50 for sending an information code via an audio signal according to another embodiment of the invention first modulates the set of binary digits 0x1ED5DA (binary digits represented in hex) and a sync header into an audio signal in the second band, where the sync header is a kind of fixed data for judging the position of the information code, for example, the sync header is 0xFFFFFF (binary digits represented in hex) or of course can be 0x0000, 0xFFFFFFFF, etc., and neither the contents nor the number of bits thereof will be limited in the invention. Moreover the sync header 0xFFFFFF is different from the data in the information code so that the sync header can be identified accurately upon reception without mistakenly taking the data in the information code as the sync header, that is, the binary code of the information code is a code of more than 24 bits, e.g., 64 bits or 128 bits, and then the same part of the data as the sync header 0xFFFFFF will not be present in the 64-bit or 128-bit binary code. Of course the foregoing description is merely illustrative but shall not be construed to limit the number of bits and the form of the information code and the sync header. Moreover the sync header 0xFFFFFF is cyclic in the audio signal and preferably cycled at an interval of not more than 20 minutes. Thus the repeated sync header 0xFFFFFF can be received on a number of occasions during reception so that the starting position of the information code data 0x1ED5DA can be judged more easily and accurately. Furthermore the second band of the audio signal is an ultrasonic band of, e.g., 24 KHz or an infrasonic band of, e.g., 15 Hz, which is inaudible to average human ears; and additionally the modulation scheme can be frequency modulation or amplitude modulation or phase modulation or another modulation scheme.

Thereafter the superimposition device 502 in the apparatus 50 for sending an information code via an audio signal according to another embodiment of the invention superimposes the modulated audio signal in the second band of 24 KHz or 15 Hz with the audio signal in the first band. Finally the transmitting device 503 in the apparatus 50 for sending an information code via an audio signal according to another embodiment of the invention transmits the superimposed audio signals in the first band and the second band together with the video signal for playing. Thus the video signal includes the picture of the product, i.e., perceptive awareness of the product, e.g., the structure, the color, the shape, etc., thereof; and the impression of the product can be enhanced by listening to the audio signal in the first band; and lastly the audio signal in the second band modulated with the information about the name, the price, the website, index or a combination thereof includes the further detailed description of the product.

FIG. 6 illustrates a block diagram of an apparatus 60 for retrieving an information code according to another embodiment of the invention.

For example, a specific video advertisement is being played, where the video advertisement can be a silent video or a phonic video, that is, the video advertisement may or may not include an audio segment in the first segment audible to human ears. Of course the video segment of the video advertisement is used to play the picture of the product, and the audio segment in the first band is used to play dissemination information, e.g., advertisement words, which can enter rapidly and reside persistently in the human brain, and other information about the product, e.g., the name, the price, the web address, the index or a combination thereof can be modulated into an audio signal in the second band in the form of the information code, where the second band is an ultrasonic band or an infrasonic band so as to avoid the influence on listening to the audio or watching the video in the first band; and additionally the modulation scheme can be frequency modulation or amplitude modulation or phase modulation. Typically the video segment and the audio segment of the video advertisement (only in the second band or in both the first band and the second band) are transmitted together for playing.

Specifically the audio signal in the second band in the video advertisement being played is modulated, for example, with the price information code of the product, for example, the binary code of the price information is a set of 24-bit binary digits 0x1ED5DA (binary digits represented in hex) or can be 16 bits, 32 bits, 64 bits or more dependent upon the length thereof. In order to retrieve the information code and thus the information, as illustrated in FIG. 6, the receiving device 601 in the apparatus 60 for retrieving an information code according to another embodiment of the invention first receives a transmission audio signal, where the transmission audio signal can only include an audio signal in the second band, e.g., of 24 KHz and 48 KHz (for example, modulated digitally at the first carrier frequency of 24 KHz and the second carrier frequency of 48 KHz), and the audio signal is modulated with a price information code 0x1ED5DA and a sync header 0xFFFFFF; or the transmission audio signal is superimposition of both the audio signal modulated with the price information code 0x1ED5DA and the sync header 0xFFFFFF and an audio signal in the first band. Specifically, for example, the audio signals at 24 KHz and 48 KHz modulated with the price information code 0x1ED5DA and the sync header 0xFFFFFF can be received by an audio sensor integrated in a mobile communication device, e.g., a handset, and converted into a digital audio signal and stored in a buffer. Thereafter the retrieval deice 602 in the apparatus 60 for retrieving an information code according to another embodiment of the invention retrieves the audio signals at 24 KHz and 48 KHz from the received transmission audio signal, where if the received transmission audio signal includes only the audio signals at 24 KHz and 48 KHz, then they can be retrieved directly; and if the received transmission audio signal includes the audio signals at 24 KHz and 48 KHz and also the audio signal in the first band, then the audio signals at 24 KHz and 48 KHz can first be separated, e.g., filtered (high-pass or low-pass), from the audio signal in the first band, and then retrieved. Specifically the audio signals at 24 KHz and 48 KHz, modulated with the price information code 0x1ED5DA and the sync header 0xFFFFFF, stored in the buffer can be extracted by a corresponding high-pass filter while filtering out the audio signal in the first band.

Finally the demodulating device 603 in the apparatus 60 for retrieving an information code according to another embodiment of the invention demodulates the audio signals at 24 KHz and 48 KHz to retrieve the information code 0x1ED5DA, where the audio signals in the second band are modulated with the price information code 0x1ED5DA and the sync header 0xFFFFFF, and the sync header is a kind of fixed data for judging the position of the information code. Moreover, of course, the sync header can alternatively be 0x0000, 0xFFFFFFFF, etc., and neither the contents nor the number of bits thereof will be limited in the invention. Moreover the sync header 0xFFFFFF is different from the data in the information code 0x1ED5DA so that the sync header can be identified accurately upon reception without mistakenly taking the data in the information code as the sync header, that is, for example, the binary code of the information code is a code of more than 24 bits, e.g., 64 bits or 128 bits, and then the same part of the data as the sync header 0xFFFFFF will not be present in the 64-bit or 128-bit binary code. Of course the foregoing description is merely illustrative but shall not be construed to limit the number of bits and the form of the information code and the sync header. Moreover the sync header 0xFFFFFF is cyclic in the audio signal and preferably cycled at an interval of not more than 20 minutes. Thus the repeated sync header 0xFFFFFF can be received on a number of occasions during reception so that the starting position of the information code data 0x1ED5DA can be judged more easily and accurately. Furthermore the corresponding demodulation scheme can be adopted with respect to the modulation scheme of frequency modulation or amplitude modulation or phase modulation. Specifically in this embodiment, for example, the retrieved audio signals at 24 KHz and 48 KHz can demodulated in a handset to retrieve the digital information codes modulated therein including the sync header 0xFFFFFF and the price information code 0x1ED5DA. Specifically in this embodiment, since the digital information code is modulated digitally, it can be demodulated in an incoherent demodulation scheme (including envelope detection) and a coherent demodulation scheme (sync detection), for example, the incoherent demodulation scheme includes frequency discrimination, split filter envelope detection, zero-crossing detection, etc. After demodulation, first the sync header 0xFFFFFF is located, and thereafter the position of the information code 0x1ED5DA can be judged from the sync header to thereby obtain the information code 0x1ED5DA. Then the price information of the product can be retrieved by the information code 0x1ED5DA through specific encoding or mapping or directly.

In a practical application, the apparatus 60 for retrieving an information code according to an embodiment of the invention as illustrated in FIG. 6 can be embodied as a part of the mobile communication device, e.g., the handset, but the invention will not be limited there. The advantage thereof is that the information code and thus the information can be retrieved at any time anywhere by a handset which is a communication facility the mostly applied today to thereby achieve advertisement and dissemination effects.

Although the invention has been illustrated and described in details in the drawings and the foregoing description, it shall be considered that the illustration and the description are illustrative and exemplary but not limitative; and the invention will not be limited to the embodiments described above.

Those ordinarily skilled in the art can appreciate and make other variations to the disclosed embodiments upon review of the description, the disclosure and the drawings as well as the appended claims. In the claims, the term “comprise” will not preclude another element or step, and the term “a/an” will not preclude plural. In a practical application of the invention, function of more than technical features recited in a claim may be performed by a single element. Any reference numerals in the claims shall not be construed to limit the scope of the invention.

1. A method of sending an information code via an audio signal, the method comprising the steps of:
A. modulating the information code and a sync header into the audio signal in a second band; and
B. transmitting the modulated audio signal in the second band directly, or superimposing and then transmitting the modulated audio signal in the second band with an audio signal in a first band, wherein the first band is different from the second band.

2-22. (canceled)
